(19) United States
(12) Patent Application Publication
(10) Pub. No.: US 2010/0000830 A1
(43) Pub. Date: Jan. 7, 2010

(54) BRAKE FOR A LINEARLY AND ROTATORILY DISPLACEABLE SHAFT

(75) Inventors: Thomas Budde, Wurzburg (DE); Aziz Inalkac, Neuklrchen-Vluyn (DE); Mykhaylo Toldonov, Bamberg (DE); Rolf Vollmer, Gersfeld (DE)

Correspondence Address: HENRY M FEIEREISEN, LLC;HENRY M FEIEREISEN, 708 THIRD AVENUE, SUITE 1501, NEW YORK, NY, 10017, US

(73) Assignee: Siemens Aktiengesellschaft, Munchen (DE)

(21) Appl. No.: 12/524,276

(22) PCT Filed: Jan. 24, 2008
(86) PCT No.: PCT/EP08/50810

§ 371 Date: Jul. 23, 2009

(30) Foreign Application Priority Data
Jan. 26, 2007 (DE) 10 2007 004 095.6

(51) Int. Cl. F16D 55/30; F16D 65/14

(52) U.S. Cl. 188/218 XL; 188/246

(57) ABSTRACT

During combined rotatory-linear displacements of a shaft (2), either both motions, or one of them, is supposed to be decelerated without high energy expenditure in a simple manner. To this end, a brake comprising a brake holder (1) and at least two arc-shaped brake shoes (5) are proposed, which are each provided with a brake lining, are fastened to the brake holder (1), and can be pressed against the displaceable shaft (2). In this way, advantageously both the linear motion and the rotatory motion of the shaft (2) can be decelerated. In order to decelerate only the linear motion, an axially fixed brake sleeve, which is rotatorily mounted on the shaft, can be used. Furthermore, a linear ball bushing can be used to decelerate the rotatory motion without influencing the linear motion.

The present invention relates to a brake for decelerating a linearly and rotatorily displaceable shaft. Such a brake can in particular be used for rotary-linear engines.

Combination drives which generate a rotational-linear movement require a fixing of an axis of movement (linearly or rotatorily) in certain applications. This fixing of the one axis of movement was hitherto achieved by position control of the respective axes. Position control represents, however, a very energy-intensive solution which it is best to avoid.

Furthermore it is necessary in certain circumstances in the case of combination drives to fix the shaft during normal operation or provide an emergency stop function. This can in turn be achieved by position control but leads to the corresponding energy and control outlay.

The object of the present invention thus lies in being able to ensure deceleration and fixing of a linearly and rotatorily displaceable shaft in a simple and low-cost manner.

This object is achieved according to the invention by a brake for decelerating a linearly and rotatorily displaceable shaft with a brake holder and at least two arc-shaped brake shoes which are each fitted with a brake lining, which are fastened on the brake holder and which can be pressed against the displaceable shaft.

Furthermore, according to the invention, a brake is provided for decelerating a linearly and rotatorily displaceable shaft with a brake holder, a linear ball-type nipple which can be mounted linearly displaceably but rotationally fixed on the shaft, a brake disk which is connected to the linear ball-type nipple in a rotationally fixed manner and a brake device for deceleration of a rotational movement of the brake disk.

With the brakes according to the invention, it is thus possible either to decelerate both movements, the rotatory and the linear, simultaneously or decelerate one of these two movements, wherein the other movement remains uninfluenced. The energy expenditure for deceleration is in any case significantly reduced in comparison to the known position control for decelerating such movements.

Two of the brake shoes of the brake cited first are preferably mounted in a rotatorily displaceable manner on a common axis on the brake holder. The brake shoes can thus not only pivot symmetrically, rather the rotatory forces can also be transmitted via the joint axis onto the brake holder.

For fixing and deceleration both of the linear and also the rotatory axis of movement, it is advantageous if the at least two brake shoes rub directly on the surface of the shaft during braking. The brake or fixing device is thus easy to achieve in terms of design.

In one special embodiment, the brake can have a brake sleeve which can be mounted with the help of a rotary bearing device on the shaft, wherein the at least two brake shoes can be pressed against the brake sleeve for deceleration of the linear movement of the shaft. A rotationally invariant, linear brake is thus advantageously produced with which linear movement can be decelerated but rotational movement remains unaffected.

In the case of a different embodiment, the brake can have a linear ball-type nipple in which the shaft can be mounted, wherein the at least two brake shoes can be pressed against the linear ball-type nipple for deceleration of the rotational movement of the shaft. As a result, a linearly invariant, rotatory brake can be achieved with which the rotational movement is decelerated but the linear movement remains unaffected.

In the case of the second solution variant shown above of a brake according to the invention with the linear ball-type nipple, the brake device can have a spring-operated brake. This is particularly advantageous for emergencies when the pretensioned spring leads to deceleration of the shaft without external energy expenditure.

The spring-operated brake can be held electromagnetically in a non-decelerating state. An electromagnetic system for holding back the brake components has generally proved to be particularly expedient with regard to reliability and design outlay.

The linear ball-type nipple of the brake according to the invention can be mounted with a two-row angular ball bearing on the brake holder. As a result of this angular ball bearing, not only radial loads but also axial loads can be absorbed in both directions.

The present invention will now be explained in greater detail with reference to the enclosed drawings, in which:

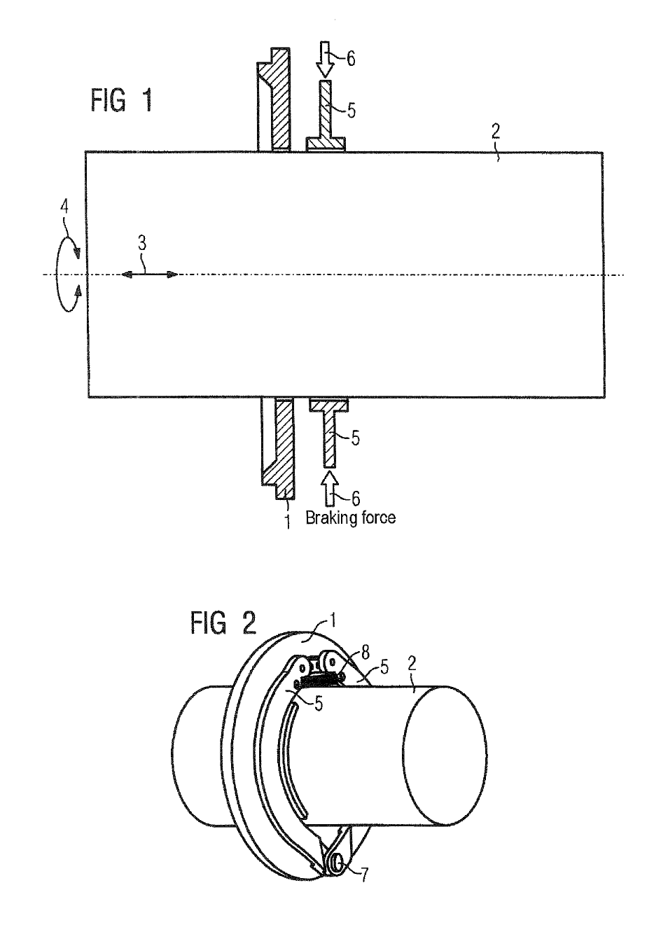

FIG. 1 shows a cross-section through a holding brake according to the present invention for a rotary-linear engine;

FIG. 2 shows a perspective view of the holding brake from FIG. 1;

FIG. 3 shows a cross-section through a rotationally invariant, linear brake according to the present invention;

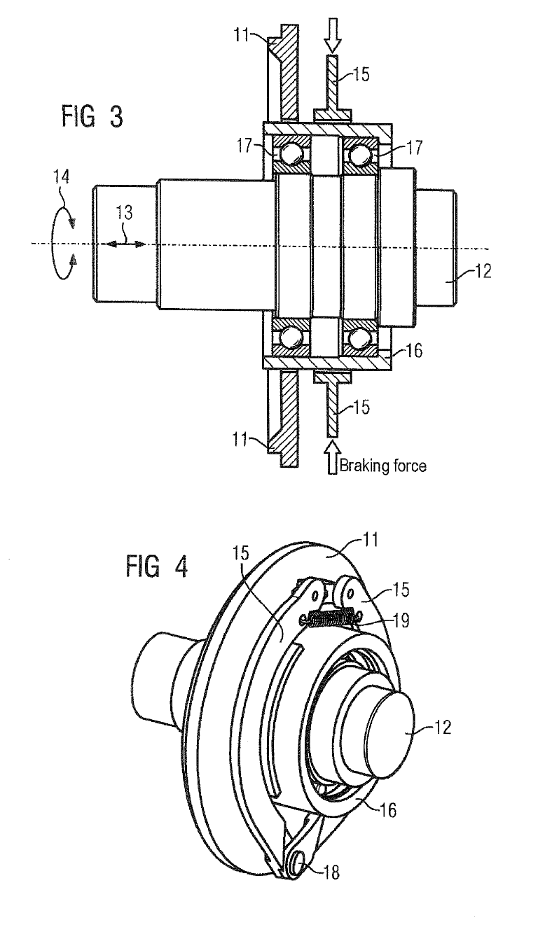

FIG. 4 shows a perspective view of the brake from FIG. 3; and

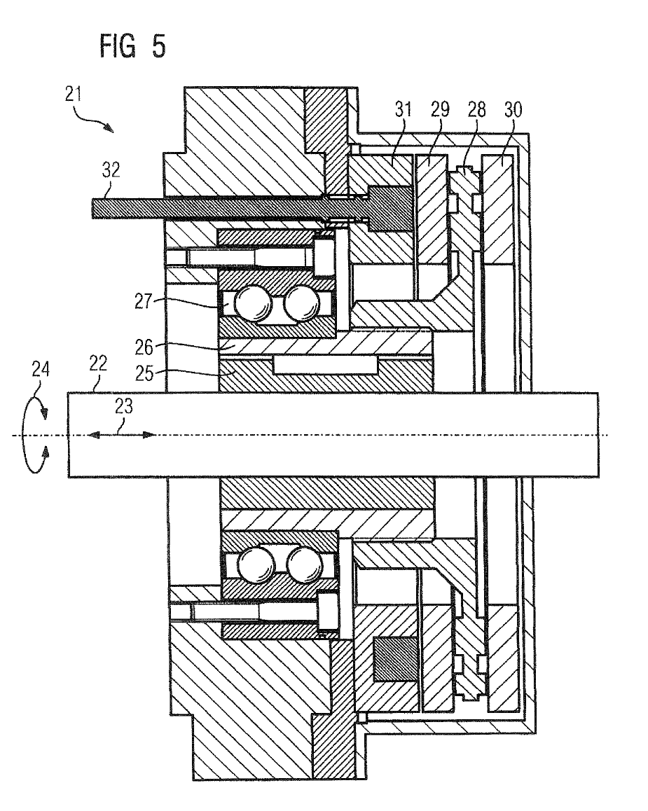

FIG. 5 shows a cross-section through a linearly invariant, rotatory brake according to one embodiment of the present invention.

The exemplary embodiments described in greater detail represent preferred embodiments of the present invention.

The holding brake shown in cross-section in FIG. 1 is simultaneously used to fix the output shaft of a rotary-linear engine, not shown, in the rotatory and linear axis of movement. The holding brake has in this case a brake holder 1 which annularly surrounds shaft 2 to be decelerated. Shaft 2 is linearly and rotatorily displaceable in accordance with arrows 3 and 4.

Two shells 5, i.e. arc-shaped shoes, with a brake lining are formed on brake holder 1. A radial braking force 6 which presses shells 5 against shaft 2 respectively acts on shells 5. As a result of the direct action of the brake shoes or shells 5 on the surface of shaft 2, both its rotatory and its linear movement is decelerated. If shaft 2 is not moved, it can be fixed by the brake for both axes of movement.

FIG. 2 reproduces the brake from FIG. 1 in a perspective view. Both brake shoes or shells 5 are rotatably mounted on brake holder 1 jointly on a bearing 7. Both shells are pulled together at their free end by a spring 8. The holding brake thus decelerates shaft 2 without external energy supply. In order to ensure the free running of shaft 2, both shells 5 are held apart by an electromagnetic system, not shown, or by a different system which operates in an analogous manner. A power failure then automatically leads to the deceleration or fixing of shaft 2.

In the case of special applications, it may be necessary to only decelerate the linear movement of shaft 2. The rotationally invariant, linear brake, schematically represented in FIG. 3, can be used for this application. In turn, a brake holder 11 surrounds a shaft 12. The shaft is linearly and rotatorily movable according to arrows 13 and 14. Shells 15, which are fitted with brake linings, do not press, however, here onto shaft 12, but rather onto a brake sleeve 16. The latter is mounted in an axially fixed and rotationally movable manner by means of a rotational bearing 17 on shaft 12.

In the non-decelerating state of the brake, brake sleeve 16 moves rotatorily and linearly with shaft 12. In the event of deceleration, however, brake sleeve 16 is fixed in its rotatory and linear movement by shells 15 with the brake linings. Therein, shaft 12 is held by rotational bearing 17, which is designed here as a double-ball bearing, in its axial position. It furthermore, however, possesses a degree of rotatory freedom. This means that, even if brake sleeve 16 is fixed, shaft 12 can rotate further in brake sleeve 16. The brake is invariant to the rotational movement.

FIG. 4 shows the rotationally invariant, linear brake from FIG. 3 in one embodiment in a perspective view. In contrast to the example of FIG. 2, brake sleeve 16 is apparent here which annularly surrounds shaft 12. In this example too, arc-shaped brake shoes 15 are jointly mounted on a bearing 18 and are tensioned together with a spring 19 at their free ends.

The functions of the individual components have already been explained above in conjunction with FIGS. 2 and 3.

FIG. 5 finally shows a further embodiment of the present invention, namely a linearly invariant, rotatory brake. A brake holder 21 in turn annularly surrounds a shaft 22. Shaft 22 is linearly and rotatorily movable in accordance with arrows 23 and 24. It is mounted in a rotationally fixed manner in a linear ball-type nipple 25 (cf. DE 39 10 457 A1). Linear ball-type nipple 25 itself is surrounded by a sleeve 26. A two-row angular ball bearing is pressed onto this for rotatory bearing of sleeve 26 on brake holder 21. Two-row angular ball bearing 27 absorbs forces in both axial directions 23.

A brake disk 28 is furthermore fastened with a certain degree of axial play on sleeve 26 in a rotationally fixed manner. Annular brake linings 29 and 30 are arranged on both sides of the brake disk. A spring force mechanism, not shown, presses brake lining 29 onto brake disk 28 and this further onto second brake lining 30.

In the non-decelerating state, an electric magnet 31 holds brake lining 29 away from brake disk 28. The electric magnet is actuated by an electrical line 32. Should electromagnet 31 not be supplied with electricity, the brake engages and shaft 22 is decelerated or fixed by the transfer of torque from brake disk 28 onto shaft 22. Therein, rotationally fixed linear ball-type nipple 25 enable, however, a degree of linear freedom of shaft 22. Linear ball-type nipple 25 is held in the axial position by ball bearing 27.

A brake, which can fix or decelerate the rotatory movement specifically in the case of a combination drive, but is invariant to linear movement, is thus advantageously present as a result of the linearly invariant, rotatory brake according to the exemplary embodiment of FIG. 5.

The brake according to the invention is particularly used in the case of rotary-linear engines. Therein, in one preferred embodiment, the engine accommodates the brake in its housing itself or even in its laminated core such that an extremely compact drive is created for rotatory and linear movements as well as for the respective deceleration processes.

Such drives can be used in particular for production machines in the fields of wood-working, metal-working, plastic-processing (plastic injection molding) and also food. Therein, rotatory and linear supply and defined braking procedures or holding torques are important for the respective standstill.

1.-12. (canceled)

13. A brake for decelerating a movement of a shaft, said brake comprising:
a brake holder;
a plurality of arc-shaped brake shoes, each fitted with a brake lining fastened on the brake holder; and
a brake member in cooperative relationship with the shaft;
wherein the brake shoes are pressable against the brake member for deceleration of a one movement of the shaft selected from the group consisting of a linear movement and a rotational movement, in the absence of an influence on the other movement of the shaft.

14. The brake of claim 13, wherein the brake member is a brake sleeve, and further comprising a rotary bearing device for support of the brake sleeve on the shaft, said brake shoes being pressable against the brake sleeve for deceleration of the linear movement of the shaft.

15. The brake of claim 13, wherein the brake member is a linear ball-type nipple for support of the shaft, said brake shoes being pressable against the linear ball-type nipple for deceleration of the rotational movement of the shaft.

16. The brake of claim 13, wherein two of the brake shoes are mounted in a rotatorily displaceable manner on a common axis on the brake holder.

17. A brake for decelerating a linearly and rotatorily displaceable shaft, said brake comprising:
a brake holder;
a linear ball-type nipple mounted on the shaft to allow a linear movement thereof but prevented from rotating in relation to the shaft;
a brake disk connected to the linear ball-type nipple in fixed rotative engagement to prevent the brake disk from rotating in relation to the linear ball-type nipple; and
a brake device for deceleration of a rotational movement of the brake disk.

18. The brake of claim 17, wherein the brake device includes a spring-operated brake.

19. The brake of claim 18, wherein the spring-operated brake is held electromagnetically in a non-decelerating state.

20. The brake of claim 17, further comprising a two-row angular ball bearing for support of the linear ball-type nipple on the brake holder.

21. A rotary-linear engine with a rotatory and linear axis of movement, said rotary-linear engine comprising a brake which includes a brake holder, a plurality of arc-shaped brake shoes, each fitted with a brake lining fastened on the brake holder, and a brake member in cooperative relationship with the shaft, wherein the brake shoes are pressable against the brake member for deceleration of a one movement of the shaft selected from the group consisting of a linear movement and a rotational movement, in the absence of an influence on the other movement of the shaft.

22. The rotary-linear engine of claim 21, wherein the brake member is a brake sleeve, and further comprising a rotary bearing device for support of the brake sleeve on the shaft, said brake shoes being pressable against the brake sleeve for deceleration of the linear movement of the shaft.

23. The rotary-linear engine of claim 21, wherein the brake member is a linear ball-type nipple for support of the shaft, said brake shoes being pressable against the linear ball-type nipple for deceleration of the rotational movement of the shaft.

24. The rotary-linear engine of claim 21, wherein the brake is integrated in an engine or engine housing.

25. A rotary-linear engine with a rotatory and linear axis of movement, said rotary-linear engine comprising a brake which includes a brake holder, a linear ball-type nipple mounted on the shaft to allow a linear movement thereof but prevented from rotating in relation to the shaft, a brake disk connected to the linear ball-type nipple in fixed rotative engagement to prevent the brake disk from rotating in relation to the linear ball-type nipple, and a brake device for deceleration of a rotational movement of the brake disk.

26. The rotary-linear engine of claim 25, wherein the brake is integrated in an engine or engine housing.

27. A production machine with at least one rotary-linear engine as claimed in claim 21.

28. A production machine with at least one rotary-linear engine as claimed in claim 25.
